(19) United States
(12) Patent Application Publication
(10) Pub. No.: US 2015/0273753 A1
(43) Pub. Date: Oct. 1, 2015

(54) REDUCED WEAR EXTRUDER SCREW

(71) Applicant: Barr, Inc, Onsted, MI (US)

(72) Inventors: Robert A. Barr, Bondurant, WY (US); Jeffrey A. Myers, Onsted, MI (US)

(21) Appl. No.: 14/601,528

(22) Filed: Jan. 21, 2015

Related U.S. Application Data
(60) Provisional application No. 61/970,938, filed on Mar. 27, 2014.

(51) Int. Cl. B29C 47/60; B29B 7/42

(52) U.S. Cl. CPC B29C 47/6075; B29C 47/6012; B29B 7/42

(57) ABSTRACT

An extruder screw comprises a core extending longitudinally from a feed end to a discharge end thereof. The core has a helical primary thread formed thereon. At least one discontinuity is fog lied in the primary thread to divide the primary thread into a plurality of primary thread portions spaced apart from each other in a longitudinal direction of the core. The at least one discontinuity formed in the primary thread may be formed adjacent a downstream end of a compression section of the screw or spanning a transition from the compression section to a section of the screw disposed downstream of the compression section. The discontinuity in the primary thread militates against the problem of solids wedging by allowing any solid materials being processed by the extruder screw to expand and break apart prior to the core reaching a maximum outer diameter.

### CROSS-REFERENCE TO RELATED APPLICATIONS

This application claims priority to U.S. Provisional Application Ser. No. 61/970,938, filed Mar. 27, 2014, the entire disclosure of which is hereby incorporated herein by reference.

### FIELD OF THE INVENTION

The present invention relates to an improved screw for use in an extruder for working a wide range of solid materials into a substantially homogeneous, molten state suitable for formation into a multitude of desired shapes by extrusion or injection into a die, mold, or casting form. More particularly, the improved screw of the present invention is most readily incorporated into what is known as a single screw extruder.

### BACKGROUND OF THE INVENTION

Extruder screws are used for transforming solid materials into a molten mixture for subsequent use in a mold or die via extrusion or injection. Materials that are used for this purpose include a range of plastic materials, as well as various metal or thixotropic materials. The screw consists of a generally cylindrical body with at least one helical thread formed thereon. The outer diameter of the thread is known as the main diameter of the screw, and the areas between the main diameters are known as channels of the screw. In some screw designs, two channels of different depths may be formed between each subsequent turn of the primary helical thread defining the main diameter of the screw, wherein a secondary thread may form a barrier between the two channels. The screw is disposed in a cylindrical barrel and a small clearance exists between the main diameter of the screw and the interior wall forming the barrel. The barrel is heated in order to conduct heat to the solid materials contacting the barrel as they progress through the channels to promote melting of the solid materials.

Extruder screws typically include a feed section, a compression section, and a metering section. The feed section is formed at a feed end of the screw where the solid materials are first introduced into the channels of the screw. The feed section of the screw includes a substantially constant channel depth that is relatively larger than the depth of the channels formed in the compression and melting section (“compression”) or the metering section. The compression section of the screw includes one of the channels formed between each turn of the primary helical thread gradually decreasing in depth as the screw extends in a direction from the feed end thereof to a discharge end thereof. Accordingly, the compression section generally includes an increasing outer diameter of the body of the screw to give the compression section of the screw a substantially conical appearance. The metering section of the screw typically includes a substantially constant channel depth that is relatively smaller than the depth of the channel formed in the feed section.

One problem typically encountered by extruder screws of various different designs is that of “solids wedging.” Solids wedging may occur when the output rate of the screw exceeds the melting capacity of the screw. As described hereinabove, the compression section of the screw includes a gradually decreasing depth of at least one of the channels formed therein and a corresponding increase in the outer diameter of the body of the screw. As the solid materials progress along the compression section of the screw, the solid materials may be compacted into a solid bed that becomes substantially incompressible. If the solid bed is not melted or softened quickly enough by the addition of heat energy, the solid bed may become wedged between one of the channels and the barrel due to the substantially tapered depth profile of the screw along the compression section.

The wedging of the solid bed can produce tremendous pressures within the barrel due to the incompressibility of the solid bed and the enormous torque used to drive the extruder screw. These pressures cause the screw to be briefly bent away from the side of the screw having the wedged solid material and toward the barrel wall formed opposite the solid wedge. The primary thread of the screw may contact the barrel wall due to the small clearance formed therebetween. This contact causes the screw to wear and may also cause the screw to become misaligned within the barrel, reducing the usefulness of the screw and potentially causing failure of the screw. The design of such screws often causes the solids wedging to occur at or adjacent to a transition from the compression section to the following section or the metering section.

It would therefore be advantageous to provide an extruder screw having an improved design that prevents solids wedging at a downstream end of the compression section of the screw.

### SUMMARY OF THE INVENTION

In accordance with the present invention, an extruder screw having a discontinuity formed in a primary thread thereof for preventing the incidence of solids wedging has surprisingly been discovered.

In an embodiment of the current invention, an extruder screw for use in a single screw extruder having a cylindrical barrel is disclosed. The extruder screw comprises a core extending longitudinally from a feed end to a discharge end thereof. The core has a helical primary thread formed thereon, wherein a first discontinuity is formed in the primary thread to divide the primary thread into a first primary thread portion and a second primary thread portion, wherein the first primary thread portion and the second primary thread portion are spaced apart from each in a longitudinal direction of the core at the end of the compression or melting section just before the following section.

In another embodiment of the invention, an extruder screw with a feed end and a discharge end for use in a single screw extruder that houses the screw rotatably within a cylindrical barrel for processing solid material to a molten state is disclosed. The screw comprises a core extending longitudinally between the feed end and the discharge end of the screw, the core including a compression section having a first end and a second end and a downstream section having a first end and a second end, wherein the second end of the compression section is formed adjacent the first end of the downstream section. A helical primary thread is formed on the core and extends at least partially into both the compression section and the downstream section. A gap region of the primary thread includes at least one gap dividing the primary thread into a plurality of primary thread portions spaced apart from each other in a longitudinal direction of the core, wherein the gap region is formed between the first end of the compression section and the second end of the downstream section.

In yet another embodiment of the invention, an extruder screw with a feed end and a discharge end for use in a single screw extruder that houses the screw rotatably within a cylindrical barrel for processing solid material to a molten state is disclosed. The screw comprises a core having an outer surface and extending longitudinally between the feed end and the discharge end and a helical primary thread formed on the outer surface of the core and including a plurality of turns about the core. The primary thread has a trailing flight facing toward the feed end and a leading flight facing toward the discharge end. At least one channel is formed on the core between adjacent turns of the primary thread. The screw further comprises a compression section having a first end and a second end, the compression section including a first channel of the at least one channels formed immediately adjacent the trailing flight of each turn of the primary thread decreasing in depth relative to the barrel as the primary thread continues through each successive turn from the first end to the second end of the compression section and a downstream section having a first end and a second end, the first end of the downstream section formed adjacent the second end of the compression section, the first end of the downstream section including the depth of the first channel ceasing to decrease in depth as the primary thread continues through each successive turn from the first end to the second end of the downstream section. The screw further comprises a gap region, wherein the gap region of the primary thread includes at least one discontinuity formed in the primary thread and divides the primary thread into a plurality of primary thread portions spaced apart from each other in a longitudinal direction of the core. The gap region is formed between the first end of the compression section and the second end of the downstream section.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a side elevational view of a standard extruder screw according to the prior art;

FIG. 2 is a schematic cross-sectional view of a portion of a barrel and a screw showing a relationship between a solid bed and a melt pool formed within a channel of the extruder screw according to the prior art illustrated in FIG. 1;

FIG. 3A is a side elevational view of a modified extruder screw having a discontinuity formed in a helical thread thereof according to an embodiment of the invention;

FIG. 3B is an enlarged view of a gap region of the extruder screw illustrated in FIG. 3A having a plurality of discontinuities formed in the helical thread thereof according to another embodiment of the invention;

FIG. 4 is a side elevational view of a standard ET or VBET screw according to the prior art;

FIG. 5A is a side elevational view of a modified ET or VBET screw having a discontinuity formed in a helical thread thereof according to an embodiment of the invention;

FIG. 5B is an enlarged view of a gap region of the modified ET or VBET screw illustrated in FIG. 5A having a plurality of discontinuities formed in the helical thread thereof according to another embodiment of the invention;

FIG. 6 is a side elevational view of a standard barrier screw according to the prior art;

FIG. 7A is a side elevational view of a modified barrier screw having a discontinuity formed in a helical thread thereof according to an embodiment of the invention; and

FIG. 7B is an enlarged view of a gap region of the modified barrier screw illustrated in FIG. 7A.

### DETAILED DESCRIPTION OF THE EXEMPLARY EMBODIMENTS OF THE INVENTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom.

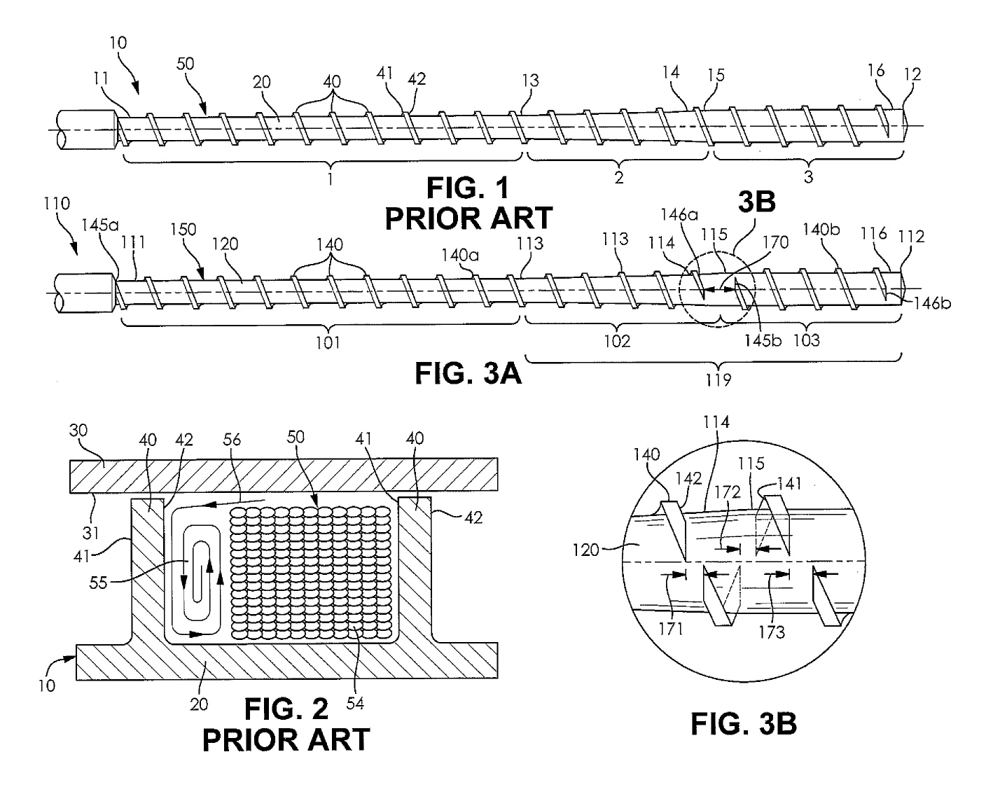

FIGS. 1 and 2 illustrate a standard feed screw 10 according to the prior art. The feed screw 10 includes a substantially cylindrical body or core 20 disposed within a barrel 30 having a substantially cylindrical hollow interior defined by a barrel wall 31, as shown in FIG. 2. The screw 10 extends from a feed end 11 thereof to a discharge end 12 thereof. The feed end 11 of the screw 10 is formed adjacent a hopper (not shown) used to deliver solid material into the barrel 30 in the form of pellets, chips, powder, shavings, or flakes, as desired. The discharge end 12 of the screw 10 typically delivers molten material out of the barrel 30 for use in an injection or extrusion molding process.

A single helical thread 40 is formed on the core 20 and is formed along a length thereof from the feed end 11 to the discharge end 12. The thread 40 extends radially outwardly from the core 20 to form a small clearance between the thread 40 and the barrel wall 31 to ensure that the solid materials introduced into the barrel 30 do not easily pass the thread 40 in an upstream or backwards direction during use of the screw 10. The thread 40 includes a trailing flight 41 facing toward the feed end 11 of the screw 10 and a pushing or leading flight 42 facing toward the discharge end 12 of the screw. A channel 50 is formed between each turn of the helical thread 40 for holding the solid material therein as it is pushed down the screw 10 during rotation of the screw 10. The channel 50 also extends helically around the screw 10 along a length thereof, wherein the channel 50 is defined by the cooperation of the trailing flight 41, the core 20, and the leading flight 42 between each turn of the thread 40. As shown in FIG. 1, the thread 40 has a substantially constant pitch along a length of the screw 10 in a manner that causes the leading flight 42 of one turn to be arranged substantially parallel to the trailing flight 41 of an adjacent and downstream turn of the thread 40. However, in some cases, the thread 40 may have a variable pitch as it continues along a length of the screw 10, as desired.

The screw 10 may comprise at least three different distinct sections, including a feed section 1 formed adjacent the feed end 11 of the screw 10, a compression section 2 disposed downstream of the feed section 1, and a metering section 3 disposed downstream of the compression section 2. The feed section 1 is defined by the core 20 having a substantially constant outer diameter, thereby causing a depth of the channel 50 relative to the barrel wall 31 to also being substantially constant along the feed section 1 of the screw 10. The feed section 1 then transitions into the compression section 2. The compression section 2 includes a first end 13 formed adjacent the feed section 1 and a second end 14 formed adjacent the metering section 3. The compression section 2 is defined as an axial length of the screw 10 wherein the outer diameter of the core 20 continually increases as it extends between each successive turn of the thread 40 as the screw 10 extends in a direction from the feed end 11 toward the discharge end 12. The increasing outer diameter (radius) of the core 20 also corresponds to a decreasing depth of the channel 50 along the compression section 2. As the depth of the channel 50 decreases, the solid material contained within the channel 50 is compressed between the barrel wall 31 and the core 20. The compression section 2 is shown in FIG. 1 as having a conically shaped taper along a length thereof to better illustrate the continually decreasing depth of the channel 50, but the compression section 2 may also be formed to have an involute taper, as desired. An involute taper is a flat spiral without a conical shape, causing an outer surface of the core 20 to be arranged substantially parallel to a longitudinal axis of the screw 10 as its outer diameter is increased or decreased relative to the barrel wall 31. Either the conical taper or the involute taper may be formed on the core 20 of the screw 10 while remaining within the scope of the present invention.

The barrel 30, which is heated by any known means, transfers heat energy to the compressed solid materials via the barrel wall 31. Additionally, the barrel wall 31 also applies a sheer stress to the solid material during rotation of the screw 10 that causes heat generating friction to be formed between the barrel wall 31 and the solid material, further heating and melting the solid material. Referring now to FIG. 2, a cross-sectional view of one of the channels 50 at the compression section 2 is illustrated. The channel 50 includes a solid bed 54 and a melt pool 55. The solid bed 54 comprises those pellets, chips, powder, shavings, or flakes that have not yet been melted and that may have been compressed by the increasing diameter of the core 20 relative to the barrel wall 31. The solid bed 54 tends to be formed within the channel 50 adjacent the trailing flight 41 of the thread 40 defining each of the channels 50. As the solid bed 54 is exposed to the heat generated by the barrel wall 31 due to conduction and sheering, a melt film 56 develops along a boundary between the solid bed 54 and the barrel wall 31. The melt film 56 may then propagate upstream within the channel 50 in a direction from the trailing flight 41 of one turn of the thread 40 and towards the leading flight 42 of an adjacent upstream turn of the thread 40. The melt film 56 combines to form the melt pool 55 adjacent the leading flight 42 of the thread 40 defining the channel 50.

The metering section 3 includes a first end 15 formed immediately adjacent the second end 14 of the compression section 2 and a second end 16 formed adjacent the discharge end 12 of the screw 10. The metering section 3 is defined by a portion of the screw 10 wherein the outer diameter of the core 20 is maximized and the depth of the channel 50 is minimized following the tapering of the core 20 throughout the compression section 2. Accordingly, the first end 15 of the metering section 3 may also be defined as a portion of the core 20 wherein the core 20 discontinues its gradual increase in outer diameter between each successive turn of the thread 40. The metering section 3 is configured to provide a homogenous supply of melted molten material and to deliver the molten material to the discharge end 12 of the screw 10.

If operating optimally, the solid bed 54 should be melted or softened to a degree that the solid bed 54 can enter the metering section 3 of the screw 10 without disturbing operation of the screw 10, wherein any materials yet to melt can continue to sheer against the barrel wall 31 such that purely molten material leaves the barrel 30 at the discharge end 12 of the screw 10. However, in some cases, a portion of the solid bed 54 may remain within the channel 50 when the channel 50 crosses over from the compression section 2 to the metering section 3 of the screw 10. Because the channel 50 continues to decrease in depth along the compression section 2 relative to the barrel wall 31, the channel 50 and the barrel wall 31 cooperate to form a wedge-shaped void therebetween. Under some circumstances, the solid bed 54 may become wedged in this void due to the inability of the barrel wall 31 to melt the compressed solid bed 54 quickly enough. A tremendous amount of pressure builds on a side of the screw 10 having the wedged solid bed 54, which in turn may cause the screw 10 to be bent within the barrel 30 such that portions of the screw 10, including the thread 40, may contact the barrel wall 31. Accordingly, the wedging of the solid bed 54 within the barrel 30 may cause significant damage to the screw 10 when an output rate of the screw 10 exceeds the ability of the screw 10 to melt the solid bed 54.

Referring now to FIG. 3A, a modified screw 110 according to the present invention is illustrated. The modified screw 110 is substantially identical to the conventional screw 10 except as described hereinafter, wherein identical structure of the modified screw 110 is denoted with the addition of 100 to the reference numerals of the conventional screw 10. Additionally, although not illustrated, it should be appreciated by one in the art that the modified screw 110 may be disposed and centered within a cylindrical barrel having a barrel wall and the components of the screw 110 may have varying depths or clearances relative to the barrel wall depending on a radial distance of each feature from an axis of rotation of the modified screw 110. The screw 110 is substantially similar to the conventional screw 10, including a feed section 101, a compression section 102, and a metering section 103. The feed section 101 and the metering section 103 may each similarly include the core 120 having a substantially constant outer diameter along a length of each respective section 101, 103, and the compression section 102 may also similarly include a gradually increasing outer diameter of the core 120 and a corresponding decrease of the depth of the channel 150 along a length of the compression section 102. The compression section 102 extends from a first end 113 formed adjacent the feed section 101 to a second end 114 formed immediately adjacent a first end 115 of the metering section 103. The metering section 103 extends from the first end 115 thereof to a second end 116 formed at or adjacent the discharge end 112 of the screw 110.

The screw 110 differs from the conventional screw 10 in that the thread 140 includes a discontinuity formed within a gap region 119 of the screw 110, wherein the gap region 119 extends from the first end 113 of the compression section 102 to the second end 116 of the metering section 103. The discontinuity forms an axial gap 170 in the thread 140 that may preferably be formed adjacent the transition from the compression section 102 to the metering section 103 of the screw 110. The discontinuity may divide the thread 140 into a first thread portion 140a and a second thread portion 140b. The first thread portion 140a may include a first end 145a formed within the feed section 101 at or adjacent the feed end 111 of the screw 110 and a second end 146a formed within the compression section 102 adjacent a transition from the compression section 102 to the metering section 103. The second thread portion 140b may include a first end 145b formed within the metering section 103 adjacent the transition from the compression section 102 to the metering section 103 and a second end 146b formed within the metering section 103 at or adjacent the discharge end 112 of the screw. The second end 146a of the first thread portion 140a may be axially spaced apart from the first end 145b of the second thread portion 140b to form the axial gap 170 between the first thread portion 140a and the second thread portion 140b.

The gap 170 is shown in FIG. 3A as spanning the transition from the compression section 102 to the metering section 103, with a portion of the gap 170 being present within the compression section 102 and another portion of the gap 170 being present within the metering section 103. The gap 170 is also shown as having an axial length approximately equal to or less than a pitch of both the first thread portion 140a and the second thread portion 140b adjacent the gap 170. Accordingly, the discontinuous portion of the thread 140 may substantially correspond to a portion of the thread 140 that would have undergone one or less full 360° turns about the substantially cylindrical core 120 at the transition from the compression section 102 to the metering section 103.

The gap 170 forming the first thread portion 140a and the second thread portion 140b aids in preventing the problem of solids wedging described hereinabove with reference to the conventional screw 10. Wedging of the solid material contained within the channel 50 of the conventional screw 10 is often most likely to occur adjacent the transition from the compression section 2 to the metering section 3 because the solid bed 54 is becoming more tightly packed as it continues down the compression section 2 while the cross-sectional area of the channel 50 is also decreasing. Accordingly, the solid bed 54 may be most likely to become wedged when it has become substantially incompressible while trying to pass into the metering section 3 from the compression section 2, as the depth of the channel 50 is shallowest along this region of the compression section 2.

The gap 170 formed in the thread 140 allows the solid bed 54 to break apart and expand into smaller pieces prior to becoming wedged between the core 120 and the barrel wall 31. As described hereinabove, the channel 150 often includes the solid bed 54 formed adjacent a trailing flight 141 of the channel 150 and the melt pool 55 formed adjacent a leading flight 142 of the channel 150. The removal of the thread 140 along the axial gap 170 allows the solid bed 54 to expand in the direction toward the metering section 103 due to the removal of the trailing flight 141, which normally acts as a boundary restricting expansion of the solid bed 54.

The gap 170 has been described as spanning a transition from the compression section 102 to the metering section 103, but the gap 170 may be formed at any suitable point within the gap region 119 to prevent the incidence of solids wedging. The gap 170 may be formed within the compression section 102 immediately adjacent the second end 114 thereof while not spanning the transition from the compression section 102 to the metering section 103, or the gap 170 may be formed in the thread 140 within one full helical turn of the thread 140 from the transition of the compression section 102 to the metering section 103, for example.

In some embodiments, the gap 170 may also coincide with a temporary increase in the depth of the channel 150 at the transition of the compression section 102 to the metering section 103. This temporary increase in the depth of the channel 150 may allow the solid materials to further expand and avoid an incidence of solids wedging. In other embodiments, only a portion of the channel 150 may include an increase in depth relative to the barrel wall.

In some embodiments, the thread 140 may include a plurality of the gaps 170 formed therein, causing the thread 140 to be broken up into at least three of the axially spaced apart thread portions. For example, referring now to FIG. 3B, the gap region 119 of the screw 110 includes a first gap 171 formed within the compression section 102 adjacent the second end 114 thereof, a second gap 172 spanning the transition from the compression section 102 to the metering section 103, and a third gap 173 formed within the metering section 103 adjacent the first end 115 thereof. A person skilled in the art should appreciate that the gap region 119 may include any combination of the first gap 171, the second gap 172, and the third gap 173, as well as additional gaps 170 formed in either of the compression section 102 or the metering section 103, as desired. As shown in FIG. 3B, each of the gaps 171, 172, 173 formed in the gap region 119 is a discontinuity in the thread 140 such that each of the plurality of thread portions follows the helical path of the thread 140 in the absence of the gaps 171, 172, 173 while maintaining an axial spacing therebetween.

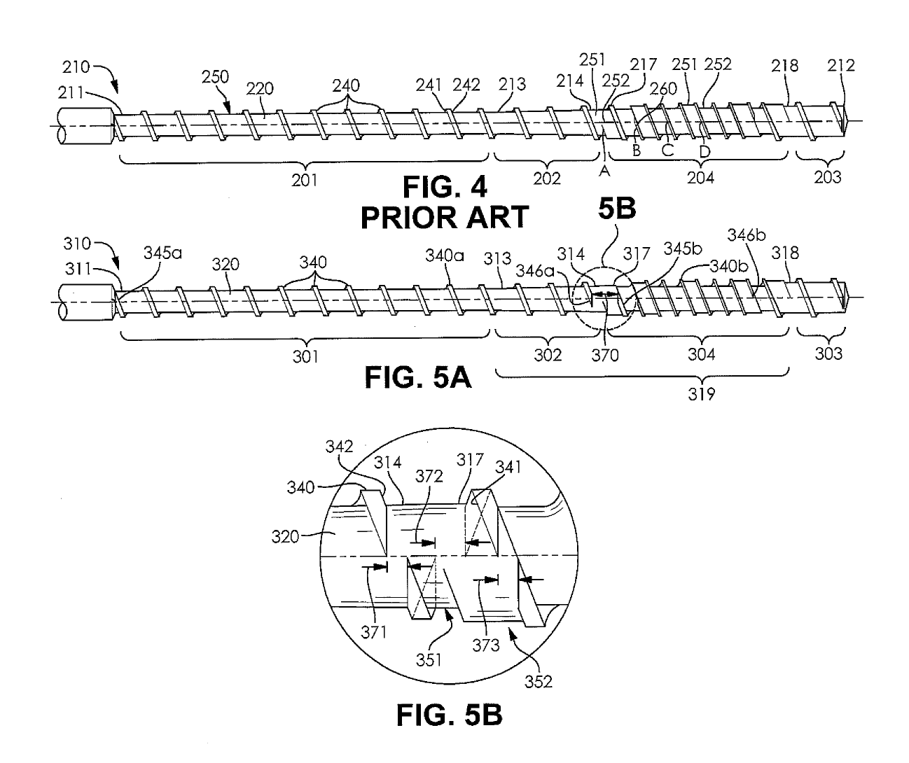

FIG. 4 illustrates a conventional energy transfer screw 210 according to the prior art. The energy transfer screw 210 may be one of an ET screw or a VBET screw, each of which have similar features as they relate to the present invention. The ET screw is described in greater detail in U.S. Pat. No. 4,405,239 to Chung et al., which is hereby incorporated by reference in its entirety. The VBET screw is described in greater detail in U.S. Pat. No. 6,599,004 to Barr, which is also hereby incorporated by reference in its entirety. Hereinafter, reference to the energy transfer screw 210 may accordingly refer to either the ET screw of the VBET screw. Additionally, although not illustrated, it should be appreciated by one in the art that the energy transfer screw 210 may be disposed and centered within a cylindrical barrel in similar fashion to the screw 10.

The energy transfer screw 210 is substantially similar to the conventional screw 10 in many respects. The energy transfer screw 210 includes a substantially cylindrical core 220 disposed within a barrel (not shown) defined by a barrel wall (not shown). The energy transfer screw 210 extends from a feed end 211 thereof to a discharge end 212 thereof. A primary helical thread 240 is formed on the core 220 and includes a trailing flight 241 and a pushing or leading flight 242. A primary channel 250 is formed between the trailing flight 241 and the leading flight 242 as the primary thread 240 extends through a plurality of turns about the core 220. Due to the helical arrangement of the primary thread 240, the primary channel 250 extends around the core 220 in a similarly helical arrangement.

The energy transfer screw 210 includes a feed section 201 and a compression section 202 that are each similar in form and function to the feed section 1 and the compression section 2 of the conventional feed screw 10 illustrated in FIG. 1. The feed section 201 is defined by the core 220 having a substantially constant outer diameter with a maximum depth of the primary channel 250. The compression section 202 is defined by the outer diameter of the core 220 gradually increasing between each successive turn of the primary thread 240 as it extends in a direction from the feed end 211 to the discharge end 212 of the energy transfer screw 210. The compression section 202 includes a first end 213 formed adjacent the feed section 201 and a second end 214 formed immediately adjacent an energy transfer section 204 of the screw 210, which is disposed downstream of the compression section 202. The energy transfer section 204 includes a first end 217 formed immediately adjacent the second end 214 of the compression section 202 and a second end 218 formed immediately adjacent the metering section 203 of the screw 210.

The energy transfer screw 210 differs from the conventional screw 10 due to the inclusion of the energy transfer section 204 formed between the compression section 202 and the metering section 203. The energy transfer section 204 may begin at a position on the core 220 where the primary channel 250 is divided into a first sub-channel 251 and a second sub-channel 252. The first sub-channel 251 is formed immediately adjacent and is partially defined by the leading flight 242 of the primary thread 240 and the second sub-channel 252 is formed immediately adjacent and is partially defined by the trailing flight 241 of the primary thread 240. As shown in FIG. 4, the division of the primary channel 250 into the first sub-channel 251 and the second sub-channel 252 begins at a point A formed on the core 220 of the energy transfer screw 210.

In some embodiments, the first sub-channel 251 initially has a gradually increasing depth relative to the barrel wall when compared to the second sub-channel 252 at point A as the first and second sub-channels 251, 252 extend toward the discharge end 212 of the energy transfer screw 210. This arrangement is illustrated in FIG. 4. In other embodiments, the second sub-channel 252 may initially have a gradually increasing depth relative to the first sub-channel 251 as the first and second sub-channels 251, 252 extend toward the discharge end 212 of the energy transfer screw 210. In either embodiment, a secondary thread 260 may extend from the core 220 at a point B positioned on a boundary between the first sub-channel 251 and the second sub-channel 252, wherein the point B may be positioned downstream of the point A by a half or a full helical turn of the boundary formed between the first sub-channel 251 and the second sub-channel 252, for example. The secondary thread 260 is helical in similar fashion to the primary thread 240 and may be arranged substantially parallel to the primary thread 240. Accordingly, a pitch of the secondary thread 260 may also be substantially equal to a pitch of the primary thread 240. The secondary thread 260 then forms the boundary between the first sub-channel 251 and the second sub-channel 252 as the energy transfer section 204 continues on in a direction toward the discharge end 212 of the energy transfer screw 210.

The energy transfer section 204 of the energy transfer screw 210 is defined by the first sub-channel 251 and the second sub-channel 252 alternatingly having increasing and decreasing depths relative to the barrel wall as the energy transfer screw 210 continues toward the discharge end 212 thereof. Additionally, the first end 217 of the energy transfer section 204 is defined by the core 220 no longer having a gradually increasing outer diameter with each successive turn of the primary thread 240. Referring to the arrangement shown in FIG. 4, for example, the first sub-channel 251 gradually increases in depth from point A to point B, wherein the depth of the first sub-channel 251 at point B is maximized. The second sub-channel 252 maintains a substantially constant depth from the point A to the point B, wherein the depth of the second sub-channel 252 at both point A and point B is minimized. Subsequently, the depth of the first sub-channel 251 remains relatively constant as the first sub-channel 251 extends from the point B to a point C, wherein the point C is formed on the secondary thread 260 about one full helical turn downstream from the point B. In contrast, the second sub-channel 252 gradually increases in depth from the point B to point C until the second sub-channel 252 has approximately the same depth of the first sub-channel 251 at point C. The first sub-channel 251 then gradually decreases in depth from point C to point D, wherein point D is formed about one full helical turn of the secondary thread 260 downstream from point C, while the depth of the second sub-channel 252 remains substantially constant from the point C to the point D. A similar pattern may then be repeated throughout the energy transfer section 204 as many times as desired.

The pattern of alternating depths of the first sub-channel 251 and the second sub-channel repeats in similar fashion along a length of the energy transfer section 204, as illustrated in FIG. 4. As the depths of the sub-channels 251, 252 vary throughout the energy transfer section 204, a clearance between the primary thread 240 and the barrel wall and a clearance between the secondary thread 260 and the barrel wall may also vary in alternating fashion. For example, the secondary thread 260 may have a gradually decreasing clearance as it extends from point B to point C while the primary thread 240 may have a gradually increasing clearance along the same segment of the energy transfer screw 210. The clearances of the primary thread 240 and the secondary thread 260 with respect to the barrel wall may become smaller along a length of the energy transfer section 204 to allow only those solid material having a small enough diameter to pass over the threads 240, 260 in a desired direction and at a desired rate.

The energy transfer screw 210 illustrated in FIG. 4 has a metering section 203 wherein the primary thread 240 has merged into the core 220 and only the secondary thread 260 continues to project from the core 220, wherein the core 220 has a substantially constant and maximized outer diameter along a length of the metering section 203. In contrast, some embodiments of the energy transfer screw 210 may include a metering section 203 wherein a transition from the energy transfer section 204 to the metering section 203 includes the secondary thread 260 being merged with into the core 220 and the primary thread 240 continuing throughout the metering section 203, as desired.

The energy transfer section 204 advantageously allows for at least a portion of the solid bed to alternate between being disposed in the first sub-channel 251 and the second sub-channel 252. The alternating clearances of the primary thread 240 and the second thread 260 alternatingly allow for the solid materials of the solid bed to be transferred from one sub-channel 251, 252 to the other sub-channel 251, 252 as the depths thereof vary, and the solid materials may accordingly be further broken up as they pass over one of the primary thread 240 and the secondary thread 260. The broken up solid materials are mixed with the melt pool contained in one of the sub-channels 251, 252 to aid in further melting the solid materials and creating a more homogenous temperature of the melt pool as it reaches the metering section 203 of the energy transfer screw 210.

Despite the inclusion of the energy transfer section 204, the energy transfer screw 210 may still suffer from the potential problem of solids wedging at a transition from the compression section 202 to the energy transfer section 204 due to the gradually decreasing depth of the primary channel 250.

Referring now to FIG. 5A, a modified energy transfer screw 310 according to the present invention is illustrated. The energy transfer screw 310 is substantially identical to the energy transfer screw 210 except as described hereinafter, wherein identical structure of the modified energy transfer screw 310 is denoted with the addition of 100 to the reference numerals of the conventional energy transfer screw 210. Additionally, although not illustrated, it should be appreciated by one in the art that the modified energy transfer screw 310 may be disposed and centered within a cylindrical barrel in similar fashion to the screw 10.

The energy transfer screw 310 differs from the conventional energy transfer screw 210 in that the primary thread 340 includes a discontinuity formed within a gap region 319 of the energy transfer screw 310, wherein the gap region 319 extends from the first end 313 of the compression section 302 to the second end 318 of the energy transfer section 304. The discontinuity forms an axial gap 370 in the primary thread 340 that may preferably be formed adjacent the transition from the compression section 302 to the energy transfer section 304. The discontinuity divides the primary thread 340 into a first primary thread portion 340a and a second primary thread portion 340b. The first primary thread portion 340a may include a first end 345a formed within the feed section 301 at or adjacent the feed end 311 of the energy transfer screw 310 and a second end 346a formed within the compression section 302 adjacent a transition from the compression section 302 to the energy transfer section 304. The second primary thread portion 340b may include a first end 345b formed within the energy transfer section 304 adjacent the transition from the compression section 302 to the energy transfer section 304 and a second end 346b formed within one of the energy transfer section 304 or the metering section 303, depending on the manner in which the energy transfer section 304 transitions to the metering section 303. The second end 346a of the first primary thread portion 340a may be axially spaced apart from the first end 345b of the second primary thread portion 340b to form the axially extending gap 370 between the first primary thread portion 340a and the second primary thread portion 340b.

The gap 370 is shown in FIG. 5A as spanning the transition from the compression section 302 to the energy transfer section 304, with a portion of the gap 370 extending within the compression section 302 and another portion of the gap 370 extending within the energy transfer section 304. The gap 370 is also shown as having an axial length approximately equal to a pitch of both the first primary thread portion 340a and the second primary thread portion 340b adjacent the gap 370. Accordingly, the discontinuous portion of the primary thread 340 may substantially correspond to a portion of the primary thread 340 that would have undergone one full 360° turn about the substantially cylindrical core 320 at the transition from the compression section 302 to the energy transfer section 304.

The gap 370 has been described as spanning a transition from the compression section 302 to the energy transfer section 304, but the gap 370 may be formed at any suitable point within the gap region 319 to prevent the incidence of solids wedging. The gap 370 may be formed within the compression section 302 immediately adjacent the second end 314 thereof while not spanning the transition from the compression section 302 to the energy transfer section 304, or the gap 370 may be formed in the primary thread 340 within one full helical turn of the primary thread 340 from the transition of the compression section 302 to the energy transfer section 304, for example.

In some embodiments, the primary thread 340 may include a plurality of the gaps 370 formed therein, causing the primary thread 340 to be broken up into at least three of the axially spaced apart thread portions. For example, referring now to FIG. 5B, the gap region 319 of the energy transfer screw 310 includes a first gap 371 formed within the compression section 302 adjacent the second end 314 thereof, a second gap 372 spanning the transition from the compression section 302 to the energy transfer section 304, and a third gap 373 formed within the energy transfer section 304 adjacent a first end 317 thereof. A person skilled in the art should appreciate that the gap region 319 may include any combination of the first gap 371, the second gap 372, and the third gap 373, as well as additional gaps 370 formed in either of the compression section 302 or the energy transfer section 304, as desired. As shown in FIG. 5B, each of the gaps 371, 372, 373 formed in the gap region 319 is a discontinuity in the primary thread 340 such that each of the plurality of thread portions follows the helical path of the primary thread 340 in the absence of the gaps 371, 372, 373 while maintaining an axial spacing therebetween.

As shown in FIGS. 5A and 5B, the first sub-channel 351 may decrease in outer diameter and accordingly increase in channel depth along a portion of the core 320 co-extensive with one of the gaps 370 formed in the primary thread 340. The increase in channel depth of the first sub-channel 351 along one of the gaps 370 further allows the solid materials contained within the second sub-channel 352 to break apart and expand into the first sub-channel 351 to prevent the incidence of solids wedging. In other embodiments, the second sub-channel 352 may include a temporary increase in channel depth along a portion of the core 320 co-extensive with one of the gaps 370 to further prevent the solid materials contained therein from wedging between the core 320 and the barrel wall.

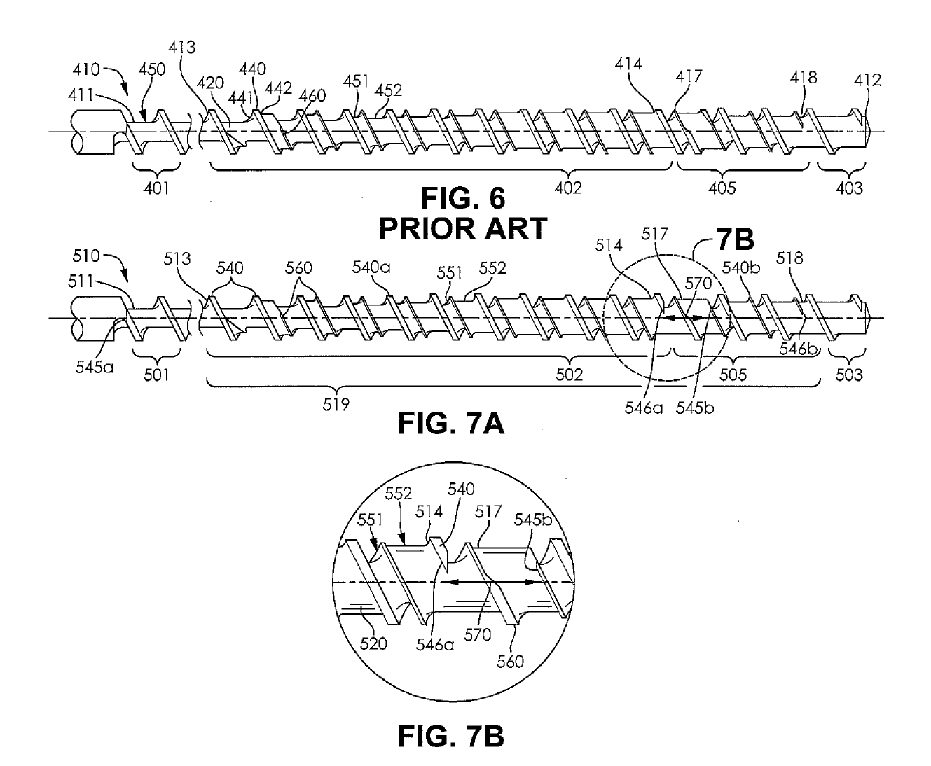

FIG. 6 illustrates a conventional barrier screw 410 according to the prior art. The barrier screw 410 may be any known form of barrier screw 410 while remaining within the scope of the present invention. One example of a barrier screw 410 is described in U.S. Pat. No. 3,698,541 to Barr, which is hereby incorporated by reference in its entirety. Additionally, although not illustrated, it should be appreciated by one in the art that the barrier screw 410 may be disposed and centered within a cylindrical barrel in similar fashion to the screw 10.

The barrier screw 410 includes a substantially cylindrical core 420 disposed within a barrel (not shown) defined by a barrel wall (not shown). The barrier screw 410 extends from a feed end 411 thereof to a discharge end 412 thereof. A primary helical thread 440 is formed on the core 420 and includes a trailing flight 441 and a pushing or leading flight 442. A primary channel 450 is formed between the trailing flight 441 and the leading flight 442 as the primary thread 440 extends through a plurality of turns about the core 420. Due to the helical arrangement of the primary thread 440, the primary channel 450 extends around the core 420 in a similarly helical arrangement.

The barrier screw 410 includes a feed section 401, a compression section 402, a melting section 405, and a metering section 403. The feed section 401 is substantially similar to that of the screw 10 and the energy transfer screw 210, wherein the core 420 has a substantially constant and minimized outer diameter along a length of the feed section 401. The feed section 401 also includes the primary thread 440 formed along a length thereof. The compression section 402 includes a first end 413 formed adjacent the feed section 401 and a second end 414 formed immediately adjacent the melting section 405. The melting section 405 includes a first end 417 formed adjacent the second end 414 of the compression section 402 and a second end 418 formed adjacent the metering section 403.

The compression section 402 of the bather screw 410, which may also commonly be referred to as the “melt section,” includes the introduction of a secondary thread 460 to divide the primary channel 450 into a first sub-channel 451 and a second sub-channel 452. The secondary thread 460 may diverge from the primary thread 440 and initially have a different pitch therefrom before establishing a spacing from the primary thread 440 to form the distinct subchannels 451, 452. The first sub-channel 451 is defined by the cooperation of the leading flight 442 of the primary thread 440, the surface of the core 420, and the secondary thread 460. The second sub-channel 452 is defined by the trailing flight 441 of the primary thread 440, the surface of the core 420, and the secondary thread 460. The first sub-channel 451 initially has a very small channel depth relative to the barrel wall and the second sub-channel 452 initially has a very large channel depth relative to the barrel wall substantially similar to the depth of the primary channel 450 within the feed section 401.

As the compression section 402 continues in a direction toward the discharge end 412 of the barrier screw 410, the first sub-channel 451 has a gradually increasing channel depth while the second sub-channel 452 has a gradually decreasing channel depth. The decreasing channel depth of the second sub-channel 452 causes the solid materials contained therein to be compressed and sheared against the barrel wall as the solid materials progress downstream along the barrier screw 410. The molten material derived by the contact of the solid materials with the barrel wall then continues backward to the first sub-channel 451 over the secondary thread 460. The secondary thread 460 may have a larger clearance relative to the barrel wall than the primary thread 440 to ensure that the solid materials can pass over the secondary thread 460 while still being wiped by the primary thread 440. The increasing cross-sectional area of the first sub-channel 451 creates an enlarging melt pool to correspond to the decreasing cross-sectional area of the second sub-channel 452 and accordingly a decreasing size of the solid bed contained therein as it continues to melt and exit the second sub-channel 452.

An end of the compression section 402 occurs when the secondary sub-channel 452 has decreased in channel depth to substantially match a channel depth of the metering section 403 of the barrier screw 410, wherein the metering section 403 of the barrier screw 410 includes the core 420 having a maximum outer diameter and a minimized channel depth. At this point, a melting section 405 of the barrier screw 410 begins wherein the first sub-channel 451 begins to decrease in channel depth to match the channel depth of the second sub-channel 452. Within the melting section 405, a clearance between the primary thread 440 and the barrel wall may gradually increase until the primary thread 440 merges into the outer surface of the core 420. Concurrently, a clearance between the secondary thread 460 and the barrel wall may decrease within the melting section 405 until the clearance between the secondary thread 460 and the barrel wall is substantially equal to the clearance between the primary thread 440 and the barrel wall along the feed section 401 of the barrier screw 410. In other embodiments, the clearance between the secondary thread 460 and the barrel wall may gradually increase until the secondary thread 460 merges into the outer surface of the core 420, and the primary thread 440 may have a gradually decreasing clearance until it resembles the primary thread 440 along the feed section 401 of the barrier screw 410, as desired.

The gradually decreasing depth of the second sub-channel 452 along the compression section 402 of the barrier screw 410 presents the issue of solids wedging in similar fashion to both the conventional screw 10 and the conventional energy transfer screw 210. The inclusion of the secondary thread 460 forming a barrier between the first sub-channel 451 and the second sub-channel 452 may cause the solid materials contained within the second sub-channel 452 to have difficulty passing the secondary thread 460 in an upstream direction, leading to the solid bed being constrained within the second sub-channel 452 in a manner that could promote wedging of the solid bed within the second sub-channel 452 if melting of the solid bed is not accomplished quickly enough to match an output rate of the barrier screw 410.

Referring now to FIG. 7A, a modified barrier screw 510 according to the present invention is illustrated. The barrier screw 510 is substantially identical to the bather screw 410 except as described hereinafter, wherein identical structure of the modified barrier screw 510 is denoted with the addition of 100 to the reference numerals of the conventional barrier screw 410. Additionally, although not illustrated, it should be appreciated by one in the art that the barrier screw 410 may be disposed and centered within a cylindrical barrel in similar fashion to the screw 10.

The modified barrier screw 510 differs from the conventional barrier screw 410 in that the primary thread 540 includes a discontinuity formed within a gap region 519 of the barrier screw 510, wherein the gap region 519 extends from the first end 513 of the compression section 502 to the second end 518 of the melting section 505. The discontinuity forms an axial gap 570 in the primary thread 540 that may preferably be formed adjacent the transition from the compression section 502 to the melting section 505. The discontinuity divides the primary thread 540 into a first primary thread portion 540a and a second primary thread portion 540b. The first primary thread portion 540a may include a first end 545a formed within the feed section 501 at or adjacent the feed end 511 of the modified barrier screw 510 and a second end 546a formed within the compression section 502 adjacent a transition from the compression section 502 to the melting section 505 thereof. The second primary thread portion 540b may include a first end 545b formed within the melting section 505 and a second end 546b formed within one of the metering section 503 and the melting section 505, depending on which of the primary thread 540 and the secondary thread 560 continues on into the metering section 503. The second end 546a of the first primary thread portion 540a may be axially spaced apart from the first end 545b of the second primary thread portion 540b to form the axially extending gap 570 between the first primary thread portion 540a and the second primary thread portion 540b.

The gap 570 is shown in FIG. 7A as spanning the transition from the compression section 502 to the melting section 505, with a portion of the gap 570 extending within the compression section 502 and another portion of the gap 570 extending within the melting section 505. The gap 570 is also shown as having an axial length approximately equal to a pitch of both the first primary thread portion 540a and the second primary thread portion 540b adjacent the gap 570. Accordingly, the discontinuous portion of the primary thread 540 may substantially correspond to a portion of the primary thread 540 that would have undergone one full 360° turn about the substantially cylindrical core 520 at the transition from the compression section 502 to the melting section 505.

The gap 570 allows the solid bed contained within the second sub-channel 552 to break apart adjacent the second end 546a of the first primary thread portion 540a. As shown in FIG. 7A, the portion of the second sub-channel 552 formed adjacent the gap 570 is continuous with the first sub-channel 551 having the melt pool primarily disposed therein, allowing the solid bed and the melt pool to mix together, further promoting melting of the solid materials contained within the second sub-channel 552. Additionally, the transfer of a portion of the solid bed from the second sub-channel 552 to the first sub-channel 551, which may have an increased depth relative to the second sub-channel 552 adjacent the gap 570, further reduces the possibility of solids wedging along the gap 570. Still, in other embodiments, the second sub-channel 552 may experience a temporary increase in channel depth relative to the barrel wall along at least a portion of the gap 570, as best illustrated in FIG. 7B. Such a temporary increase in channel depth of the second-sub-channel 552 aids in further preventing solids wedging by expanding a cross-section of the second sub-channel 552 along the transition of the compression section 502 to the melting section 505.

The gap 570 has been described as spanning a transition from the compression section 502 to the melting section 505, but the gap 570 may be formed at any suitable point within the gap region 519 to prevent the incidence of solids wedging. The gap 570 may be formed within the compression section 502 immediately adjacent the second end 514 thereof while not spanning the transition from the compression section 502 to the melting section 505, or the gap 570 may be formed in the primary thread 540 within one full helical turn of the primary thread 540 from the transition of the compression section 502 to the melting section 505, for example.

In some embodiments, the primary thread 540 may include a plurality of the gaps 570 formed therein in similar fashion to the screws 110, 310 depicted in FIGS. 3B and 5B, causing the primary thread 540 to be broken up into at least three of the axially spaced apart thread portions. For example, the gap region 519 of the modified barrier screw 510 may include a first gap (not shown) formed within the compression section 502 adjacent the second end 514 thereof, a second gap (not shown) spanning the transition from the compression section 502 to the melting section 505, and a third gap (not shown) formed within the melting section 505 adjacent a first end 517 thereof. A person skilled in the art should appreciate that the gap region 519 may include any combination of the first gap, the second gap, and the third gap, as well as additional gaps 570 formed in either of the compression section 502 or the melting section 505, as desired.

Each of the three of the screws 110, 310, 510 having at least one gap 170, 370, 570 formed in each respective primary thread 140, 340, 540 advantageously militates against the problem of solids wedging adjacent a transition from the compression section 102, 302, 502 to a downstream section 103, 304, 505 of each of the screws 110, 310, 510. In all three cases, the at least one gap 170, 370, 570 may be formed in the primary thread 140, 340, 540 at a position on each screw 110, 310, 510 where at least one channel formed between adjacent flights of the primary thread 140, 340, 540 ceases to decrease in channel depth with each subsequent turn of the primary thread 140, 340, 540. The axial gaps 170, 370, 570 militate against solids wedging by allowing the solid materials being compressed between the core 120, 320, 520 and the barrel wall to expand and break apart before a solid bed can form and become wedged at the transition from the compression section 102, 302, 502 to the downstream section 103, 304, 505.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. An extruder screw for use in a single screw extruder, wherein the extruder screw is disposed within a cylindrical barrel, the screw comprising:
a core extending longitudinally from a feed end to a discharge end thereof, the core having a helical primary thread formed thereon, wherein a first discontinuity is formed in the primary thread to divide the primary thread into a first primary thread portion and a second primary thread portion, wherein the first primary thread portion and the second primary thread portion are spaced apart from each in a longitudinal direction of the core.

2. The extruder screw according to claim 1, wherein the core includes a compression section and a downstream section disposed adjacent the compression section.

3. The extruder screw according to claim 2, wherein the first discontinuity in the primary thread spans a transition from the compression section to the downstream section.

4. The extruder screw according to claim 2, wherein the first discontinuity in the primary thread is formed adjacent a transition from the compression section to the downstream section.

5. The extruder screw according to claim 2, wherein the downstream section is one of a metering section of a standard extruder screw, an energy transfer section of one of an ET screw or a VBET screw, or a melting section of a barrier screw.

6. The extruder screw according to claim 1, wherein at least a portion of the core increases in outer diameter as the core extends in direction from the feed end to the discharge end thereof, wherein the first discontinuity is formed in the primary thread to span a portion of the core wherein the core has first reached a maximum outer diameter.

7. The extruder screw according to claim 1, wherein the primary thread includes a plurality of discontinuities formed therein to divide the primary thread into a plurality of axially spaced apart primary thread portions.

8. An extruder screw with a feed end and a discharge end for use in a single screw extruder that houses the screw rotatably within a cylindrical barrel for processing solid material to a molten state, the screw comprising:
a core extending longitudinally between the feed end and the discharge end of the screw, the core including a compression section having a first end and a second end and a downstream section having a first end and a second end, wherein the second end of the compression section is formed adjacent the first end of the downstream section;
a helical primary thread formed on the core and extending at least partially into both the compression section and the downstream section, wherein a gap region of the primary thread includes at least one gap dividing the primary thread into a plurality of primary thread portions spaced apart from each other in a longitudinal direction of the core, wherein the gap region is formed between the first end of the compression section and the second end of the downstream section.

9. The extruder screw of claim 8, wherein the downstream section of the core is one of a metering section, an energy transfer section, and a melting section.

10. The extruder screw of claim 8, wherein the compression section includes at least a portion of the core disposed between each successive turn of the primary thread gradually increasing in diameter as the compression section extends from the first end thereof to the second end thereof, and wherein a first end of the downstream section includes the core having first reached a maximum outer diameter as the core extends from the feed end to the discharge end.

11. The extruder screw of claim 10, wherein a first gap of the at least one gaps spans a transition from the compression section to the downstream section.

12. The extruder screw of claim 11, wherein a second gap of the at least one gaps is formed in one of the compression section and the downstream section.

13. The extruder screw of claim 8, wherein the primary thread includes a leading flight facing toward the discharge end of the screw and a trailing flight facing toward the feed end of the screw, wherein the core includes at least one channel formed between the leading flight and the trailing flight of each turn of the primary thread, the at least one channel including a first sub-channel formed adjacent the leading flight of the primary thread and a second sub-channel formed adjacent the trailing flight of the primary thread.

14. The extruder screw of claim 13, wherein the compression section includes the second sub-channel gradually decreasing in depth relative to the barrel as the core continues in a direction from the feed end toward the discharge end of the screw, and the first end of the downstream section includes the second sub-channel ceasing to decrease in depth relative to the barrel as the core continues in a direction from the feed end to the discharge end of the screw.

15. The extruder screw of claim 14, wherein a first gap of the at least one gaps spans a transition of the compression section to the downstream section.

16. The extruder screw of claim 8, wherein the gap region includes a first gap dividing the primary thread into a first primary thread portion formed in the compression section and a second primary thread portion formed in the downstream section, wherein the first primary thread portion and the second primary thread portion each have the same pitch adjacent the first gap.

17. The extruder screw of claim 16, wherein the first primary thread portion is spaced apart in an axial direction of the core from the second primary thread portion by a distance substantially equal to or less than the pitch of the first and second primary thread portions adjacent the first gap.

18. The extruder screw of claim 8, wherein each of the at least one gaps formed in the gap region is a discontinuity in the primary thread such that each of the plurality of primary thread portions follow the helical path of the primary thread in the absence of the at least one gaps.

19. The extruder screw of claim 8, wherein at least a portion of the core has a decreasing outer diameter along a length of the core co-extensive with the at least one gap formed in the primary thread.

20. An extruder screw with a feed end and a discharge end for use in a single screw extruder that houses the screw rotatably within a cylindrical barrel for processing solid material to a molten state, the screw comprising:
a core extending longitudinally between the feed end and the discharge end, the core having an outer surface;
a helical primary thread formed on the outer surface of the core and including a plurality of turns about the core, the primary thread having a trailing flight facing toward the feed end and a leading flight facing toward the discharge end, wherein at least one channel is formed on the core between adjacent turns of the primary thread;
a compression section having a first end and a second end, the compression section including a first channel of the at least one channels formed immediately adjacent the trailing flight of each turn of the primary thread decreasing in depth relative to the barrel as the primary thread continues through each successive turn from the first end to the second end of the compression section;
a downstream section having a first end and a second end, the first end of the downstream section formed adjacent the second end of the compression section, the first end of the downstream section including the depth of the first channel ceasing to decrease in depth as the primary thread continues through each successive turn from the first end to the second end of the downstream section; and
a gap region of the primary thread including at least one discontinuity formed in the primary thread and dividing the primary thread into a plurality of primary thread portions spaced apart from each other in a longitudinal direction of the core, wherein the gap region is formed between the first end of the compression section and the second end of the downstream section.
